(19) United States
(12) Patent Application Publication
(10) Pub. No.: US 2009/0285945 A1
(43) Pub. Date: Nov. 19, 2009

(54) COOK-STABLE ICE CREAM FILLINGS FOR USE IN CONSUMER HEATABLE PASTRY PRODUCTS

(76) Inventor: BASHOR MICHAEL, St. Louis Park, MN (US)

Correspondence Address: GENERAL MILLS, INC., P.O. BOX 1113, MINNEAPOLIS, MN, 55440, US

(21) Appl. No.: 12/465,700

(22) Filed: May 14, 2009

Related U.S. Application Data
(60) Provisional application No. 61/127,926, filed on May 16, 2008.

(51) Int. Cl. A21D 13/08; A23G 3/34

(52) U.S. Cl. 426/95; 426/580

(57) ABSTRACT

Described are cook-stable ice cream fillings that are suitable for use in filled pastry products of the type that are pre-cooked, packaged, and frozen. In many embodiments, the cook-stable ice cream fillings of the invention display a texture, consistency, and mouth-feel that is similar to ice cream. In contrast to ice cream, however, the cook-stable ice cream fillings of the invention are more tolerant of heat exposure conditions that are typical when the filled pastry is pre-cooked by the manufacturer. For example, in many embodiments, the cook-stable ice cream fillings do not melt-out or otherwise degrade during the pre-cooking operation. In addition, the cook-stable ice cream fillings of the invention remain substantially frozen when a frozen pastry product containing a cook-stable ice cream filling of the invention is heated in a toaster or microwave oven under typical heating conditions. In many embodiments, the cook-stable ice cream fillings of the invention can be dispensed by the manufacturer as high viscosity liquids onto an unbaked dough piece during the process of manufacturing the filled pastry products. Also described are toaster or microwave heatable pastries that comprise an outer pre-cooked (e.g., baked or fried) dough piece that surrounding and an inner filling layer that comprises a cook-stable ice cream filling of the invention. Methods of making cooked filled pastry products including a cook-stable ice cream filling are also described.

### CROSS-REFERENCE TO RELATED APPLICATIONS

This application claims the benefit of U.S. Provisional Application Ser. No. 61/127,926, filed May 16, 2008, and entitled COOK-STABLE ICE CREAM FILLINGS FOR USE IN CONSUMER HEATABLE PASTRY PRODUCTS, the disclosure of which is incorporated herein by reference.

### BACKGROUND

Frozen consumer-heatable pastry products that contain sweet fillings are well known. Examples include TOASTER STRUDEL brand pastries and the like. These pastry products are sold to the consumer in frozen form for heating by the consumer in a toaster or microwave oven. Typically, the pastries contain a sweet filing, for example, comprising a fruit or spice flavored jelly such as cherry, cinnamon, apple, and the like.

### SUMMARY

One desirable filling for use in a pastry product is ice cream. The flavor, texture, and temperature of ice cream complements the flavor, texture, and temperature of the pastry to provide a desirable combination. Preparing a frozen consumer-heatable pastry product with an ice cream filling is challenging, however. During a typical manufacturing process, the filling is dispensed onto a dough piece which is then folded over or laminated to a second dough piece to encase the filling. The raw filled pastry is then cooked (e.g., fried or baked), and the resulting pastry is frozen for distribution to the consumer. The cooking operation is typically conducted at a temperature of about 375° F. (190.6° C.) for a time period of about 45 seconds if fried, or at a temperature of about 400° F. (204.4° C.) for a time period of 10 minutes if baked. During this cooking operation, the ice cream is exposed to temperatures that may cause it to melt or otherwise degrade. In addition, during heating of the frozen pastry by the consumer, melting or degradation of the ice cream filling may also occur.

In view of the foregoing, what is desired is a cook-stable ice cream filling that is stable to the cooking and heating conditions that are typical in the manufacturing (i.e., pre-cooking) and reheating of consumer-heatable pastry products.

In one aspect, the invention relates to cook-stable ice cream fillings that are suitable for use in filled pastry products of the type that are pre-cooked, packaged, and frozen. The consumer reheats the frozen pastry with a toaster or microwave oven. In many embodiments, the cook-stable ice cream fillings of the invention display a texture, consistency, and mouth-feel that is similar to ice cream. In contrast to ice cream, however, the cook-stable ice cream fillings of the invention are more tolerant of heat exposure conditions that are typical when the filled pastry is pre-cooked by the manufacturer (e.g., in a frying or baking operation). Specifically, the cook-stable ice cream fillings do not melt-out or otherwise degrade during the pre-cooking operation. This makes the fillings of the invention suitable for use as fillings in mass produced pre-cooked filled pastry products. In addition, the cook-stable ice cream fillings of the invention remain substantially frozen (i.e., like ice cream) when a frozen pastry product containing a cook-stable ice cream filling of the invention is heated in a toaster or microwave oven under typical heating conditions. In addition to the desirable baking and heating properties, the cook-stable ice cream fillings of the invention are desirable since they can be dispensed by the manufacturer as high viscosity liquids onto an unbaked dough piece during the process of manufacturing the filled pastry products.

In another aspect, the invention relates to toaster or microwave heatable pastries that comprise an outer pre-cooked (e.g., baked or fried) dough piece that surrounding and an inner filling layer that comprises a cook-stable ice cream filling of the invention. The pastries are sold to the consumer frozen, and intended to be reheated using a toaster or microwave oven to provide a pastry that has a warm outer pastry layer and an inner substantially frozen cook-stable ice cream filling.

In yet another aspect, the invention relates to a method of making a cooked filled pastry, the method comprising the steps of: (a) providing a cook-stable ice cream filling of the invention; wherein the cook-stable ice cream filling is a semi-solid composition; (b) applying the cook-stable ice cream filling to a layer of an uncooked dough composition; (c) encasing the cook-stable ice cream filling in the dough piece to form an uncooked filled pastry; and (d) cooking (e.g., baking or frying) the uncooked filled pastry to form the cooked filled pastry.

### DETAILED DESCRIPTION

The invention provides cook-stable ice cream fillings, filled pastry products containing the cook-stable ice cream fillings, and methods of making the filled pastry products.

In many embodiments, the ice-cream like fillings useful in the present invention comprises water, ice cream, a high melting point fat, a moisture binding agent, and a humectant. The high melting point fat and moisture binding agent act to modify the cook-stable ice cream filling so that it can be used in a consumer heatable pastry product.

Cook-stable ice cream filling compositions of the invention comprise ice cream. Typically, the ice cream used in the cook-stable ice cream compositions comprises: (a) about 10% wt. or greater milkfat (e.g., about 10-16% milkfat); (b) 9-12% wt. milk solids (i.e., the non-fat component which contains the proteins (caseins and whey proteins) and carbohydrates (lactose) found in milk); (c) 12-16% wt. sweetener (e.g., a combination of sucrose and glucose-based corn syrup sweeteners); and (d) 0.2-0.5% wt. stabilizers and emulsifiers. The balance of the ice cream comprises water, for example, in an amount of about 55-64% wt. water. The ingredients used to make the ice cream typically include: (a) a concentrated source of the milkfat (e.g., cream or butter); (b) a concentrated source of the milk solids-not-fat component, usually evaporated milk or milk powder; (c) sugar including sucrose and glucose solids (i.e., a product derived from the partial hydrolysis of the corn starch component in corn syrup); and (d) milk. Ice cream is typically present in a cook-stable ice cream filling of the invention in an amount of about 20% wt. or greater, although other amounts may be useful.

Cook-stable ice cream fillings of the invention comprise a high melting point fat. The melting point of the high melting point fat typically ranges from about 90-125° F. (33-50° C.). Examples of high melting point fats include palm oil, palm olein, palm kernel, cottonseed oil, soybean oil, and mixtures thereof. Typically, the high melting point fat is present in the cook-stable ice cream filling in an amount ranging from about 1-30% wt., more typically ranging from about 10-30% wt.

Cook-stable ice cream fillings of the invention comprise at least one moisture binding agent that binds and thickens the filling. This moisture binding agent can function as a physical stabilizer and/or viscosifier. Examples of moisture binding agents include hydrocolloids (e.g., cellulose compounds, starch, modified starch, carrageenan, carboxymethyl cellulose, locust bean gum, guar gum, and xanthan gum). A moisture binding agent is typically present in the cook-stable ice cream filling in an amount ranging from about 0.1-8% wt., for example, about 0.2-4% wt., or about 0.5-2% wt. In many embodiments, the moisture binding agent binds the moisture and thickens the filling in order to provide a filling having a viscosity of about 90,000 cps or greater when measured at 70-73.4° F. (21-23° C.). In some embodiments, the viscosity ranges from about 90,000-240,000 cps, or from about 170,000-240,000 cps when measured at 70-73.4° F. (21-23° C.). In a specific embodiment, the viscosity of the filling is about 170,000 cps when measured at 70-73.4° F. (21-23° C.).

Cook-stable ice cream fillings of the invention comprise at least one humectant. Examples of humectants include alcohols, saccharides, gums, salts, and mixtures thereof. In some embodiments, the humectant comprises a monohydric alcohol, diol, polyol, monosaccharide, disaccharide, trisaccharide, salt, and mixtures thereof. In some embodiments, the humectant comprises glycerol, fructose, sucrose, glucose, propylene glycol, sodium chloride, sorbitol, mannitol, polydextrose, carboxymethyl cellulose, guar gum, molasses, potassium polymetaphosphate, triacetin, propionate, sodium lactate, monosodium glutamate, corn syrup, glycine, 1,2-propanediol, alginate, and mixtures thereof. The humectant is typically present in an amount ranging from about 1-7% wt.

In many embodiments, the cook-stable ice cream fillings of the invention have a melting point that is greater than the melting point that is typical of ice cream. An increased melting point provides the filling with thaw stability during the pre-cooking step that is typical in making the filled pastry products of the invention. In addition, the increased melting point provides the filling with thaw stability when the pastry is heated by the consumer, for example in a toaster or microwave oven. This allows the pastry to be served with an outer baked pastry portion that is warn or hot, and an inner filling portion that is cold like ice cream. In many embodiments, the melting point of the cook-stable ice cream filling of the invention is about 59° F. (1 5° C.) or greater or about 68° F. (20° C.) or greater. In many embodiments, the melting point of the cook-stable ice cream filling ranges from about 59-86° F. (15-30° C.).

Optional ingredients that may be useful in a cook-stable ice cream filling include flavorants, emulsifiers, particulates, and preservatives as known in the art.

TABLE A provides an exemplary formulation for a cook-stable ice cream filling of the invention.

TABLE A

| | Formulation |
|---|---|
| | Amount of Filling |
| Ingredient | (% wt.) |
| Water | 10-60 |
| Ice Cream | ≧20 |
| High Melting Point Fat | 10-30 |
| Humectant | 1-7 |
| Moisture Binding Agent | 0.1-8 |
| Emulsifier | 0-2 |
| Preservative | 0-2 |

### Procedure for Making Cook-Stable Ice Cream Filling

The cook-stable ice cream filling of the invention may be made by any procedure that will form a stable oil and water emulsion. Representative examples of processes include those described in U.S. Pat. No. 6,322,829.

To make a cook-stable ice cream filling with a relatively semi-solid consistency at ambient temperatures, one procedure is to combine all the ice cream into a mixing vessel and add the oil or fat while mixing. The humectant, moisture binding agent, and optional emulsifier are added, along with any flavoring and coloring agents to the vessel, and mixed until well blended. Water is also added to the blend to reach the desired viscosity. The ingredients thus mixed are then cooked, optionally with low mechanical stirring action, to pasteurize the filling. After the filling is cooked, it is cooled and further stored or used as desired.

To make a cook-stable ice cream filling which is flowable or pumpable at ambient temperatures, a high shear system is preferable used. The procedure generally involves preparing an oil and water emulsion first, before adding the ice cream and other ingredients to make the filling.

One procedure to make a flowable cook-stable ice cream filling is to prepare an emulsion by mixing the water and fat under high speed mixing. Optionally, a humectant can also be added at this stage. Preferably, the ingredients are mixed at a temperature high enough to melt the fat if it is in solid form. The ice cream, any emulsion stabilizer, the remaining humectant, and flavors, colors or characterizing agents are added. The temperature of the product should be kept high enough to blend the ingredients, but not so high as to scorch or burn the ingredients. Preferably, the ingredients are combined at a temperature ranging between 130° F. to 170° F. (54.4° C. to 76.7° C.). The cook-stable ice cream filling is then cooled and further processed or stored as desired.

When using the emulsion based preparation method, preferably a high shear force is applied to the oil and water mixture to form and stabilize the resulting emulsion. To prepare a stable emulsion, up to about 4000 RPM of shear force can be used, preferably between about 600-3600 RPM, and more preferable between about 3000-3600 RPM.

In some embodiments, the cook-stable ice cream filling is prepared using the ingredients listed in TABLE A. The filling is prepared by mixing all of the ice cream ingredients in a steam injected cooking vessel and mixing the ingredients. The shortening or oil is also added during this step. The humectant, moisture binding agent(s), and water can then be added and mixed. Next, the flavors and preservatives are added and the entire mix is cooked to about 160° F. (71.1° C.) and held for about 1 minute. The resulting product is then cooled and packaged and stored as desired.

### Dough Composition

The dough used to prepare the outer shell of the pastry may be any dough conventionally used in such pastry products. Typically, the dough shell is prepared from a dough composition that comprises flour (e.g., white flour or whole-wheat flour), sweeteners, fat, and water.

Flour (including white flour and whole wheat flour) is present in the dough formulation. In some embodiments, the white flour is present at a concentration of up to about 70% wt. of the dough formulation. In certain embodiments of the invention, white flour can be about 40-60% wt. of the dough formulation. In some embodiments, whole-wheat flour is present in the dough formulation at a concentration of up to about 70% wt. of the dough formulation. In certain embodiments of the invention, whole-wheat flour can be about 40-60% wt. of the dough formulation.

In some embodiments, wheat bran is present in the dough formulation at a concentration of about 0.5-5% wt. of the dough formulation. In certain embodiments of the invention, wheat bran can be about 1-3% wt. of the dough formulation.

The sweetener concentration can be up to about 22% wt. of the dough formulation depending on the desired sweetness of the filled pastry. In embodiments of the invention, sweetener concentration can be about 4-15% wt. of the dough formulation as well as about 10% wt. of the dough formulation.

Sweeteners suitable for the invention, include, for example, refiner's syrup, sucrose, sucralose, nutritive and non-nutritive sweeteners (such as acesulfame K and aspartame), molasses, corn syrups, high fructose corn syrups, corn syrup solids, honey, maple syrup, dextrose, sorbitol, other sugar alcohols and combinations thereof.

The dough composition may also include fat, which can be added in a variety of formats such as chips, liquids and solids. The fat can also be provided as a roll-in shortening as discussed in more detail below. A dough fat can be added at a concentration of up to about 15% wt. of the dough formulation. In certain embodiments of the invention, dough fat can be about 2-4% wt. of the dough formulation.

Water in the dough composition is typically present in an amount of about 30-50% wt. In embodiments of the invention, water concentration can be about 34-36% wt. of dough formulation.

The dough formulation of the invention is generally a leavened dough, although non-leavened dough is within the scope of the invention. A leavened dough can be organically leavened (e.g. yeast), chemically leavened or a combination of both.

When a yeast is used, it may be typical baker's dry yeast, and can be at a concentration of about 0.5-3% wt. of the raw dough formulation. In certain embodiments of the invention, yeast can be about 1-3% wt. of the dough formulation, as well as about 1.0-1.8% wt. of the dough formulation. Yeast can be used for leavening, as well as a flavor enhancer to provide better taste.

Chemical leaveners (i.e., systems with chemical leavening acids and bases) may also be used in preparing the dough product of the invention. The chemical leavening system used in preparing the dough products of the invention may include at least one chemical leavening base. Any chemical leavening base that is capable of undergoing the reaction is suitable for use in the dough product of the invention.

Although a base may be included to react with each chemical leavening acid, i.e., more than one base may be utilized, in an embodiment, the chemical leavening base would be capable of reacting with both of the at least two chemical leavening acids. Such chemical leavening bases are well known to those of skill in the art and, as a result, only the exemplary chemical leavening bases, sodium bicarbonate (baking soda), ammonium bicarbonate and potassium bicarbonate, are recited herein.

The chemical leavening system utilized in the dough products of the invention further may include at least two chemical leavening acids that may be classified as fast acting or slow acting. Suitable fast acting chemical leavening acids for use in the dough products of the invention include, but are not limited to, any of the sodium acid pyrophosphates (SAPP), monocalcium phosphate monohydrate (MCP), sodium aluminum sulfate (SAS), glucono delta lactone (GDL), potassium hydrogen tartrate (cream of tartar), combinations of these and the like.

Suitable slow acting chemical leavening acids include those that have a relatively lower solubility in water and require higher temperatures to react with chemical leavening bases. Consequently, slow acting chemical leavening acids typically react with a chemical leavening base later in the cooking cycle. Slow acting chemical leavening acids that are suitable for use in the dough products of the invention include, but are not limited to, sodium aluminum phosphate (SALP) and dicalcium phosphate (DCP).

In an embodiment of the invention, bicarbonate of soda is used in the dough formulation at a concentration of up to about 0.5% wt. of the dough formulation. In embodiments of the invention bicarbonate of soda can be powdered and used at a concentration of about 0.2-0.3% wt. of the dough formulation.

In an embodiment of the invention, sodium acid pyrophosphate (SAPP) is used in the dough formulation at a concentration of up to about 0.5% wt. of the dough formulation. In embodiments of the invention, SAPP can be at a concentration of about 0.2-0.3% wt. of the dough formulation.

Optionally, salt can be in a dough formulation at a concentration of about 0.5-2% wt. of the dough formulation. In embodiments of the invention, salt concentration is about 1-1.5% wt. of the dough formulation.

Emulsifying agents, such as mono- and di-glyceride emulsifiers, are well known to those in the art. The emulsifying agents, when desired, can be used at a concentration of up to about 5% wt. of the dough formulation. In embodiments of the invention, the emulsifying agent concentration can be about 0.1-3.3% wt. of the dough formulation, as well as about 0.1% wt. of the dough formulation.

Optionally, eggs can be included in the dough formulation. The eggs can be used in the form of whole egg solids at a concentration of about 0.5-3.0% wt. of the dough formulation. In embodiments of the invention whole egg solids can be at a concentration of about 1.5-2.0% wt. of the dough formulation. Egg yolk solids can also be used at a concentration of about 0.5-3.0% wt. of the dough formulation as well as about 0.85% wt. of the dough formulation.

According to a process of the invention, during the preparation of the dough formulation, the dry components can be mixed together prior to the addition of water and the leavening system. The water and leaveners can be added to the dough formulation at a controlled temperature to prevent premature proofing. The mixer can have a cooling jacket to assure that the temperature is low enough to prevent premature proofing. In other embodiments of the invention, water can be used in the form of ice.

During the initial mixing, the dough temperature can be maintained at a temperature of about 66° F. (18.9° C.) or less, as higher temperatures may result in poor sheeting characteristics and may result in premature proofing. Mixing is performed for about 3-30 minutes, and can be about 4-10 minutes depending on the quantity of ingredients used.

A dough can be prepared in a two-stage process. Depending on the speed of the mixer and ingredient quantities, the first mixing stage may be done for up to about 10 minutes as well as from about 6-8 minutes. The second mixing stage may be done for up to about 10 minutes as well as from about 2-3 minutes.

The dough shell according to exemplary embodiments of the invention can be a laminated pad that includes alternating laminations of dough and roll-in shortening. After the dough is prepared (e.g., sheeted), it is then coated with a hydrated or anhydrous roll-in shortening. The roll-in shortening can be at a concentration of about 4-22% wt. of a laminated dough pad. In embodiments of the invention, the roll-in shortening can be about 5-11% wt. of a laminated dough pad, as well as about 6-7% wt. of a laminated dough pad.

Shortening for use as a roll-in in the product may be any of conventional hydrogenated vegetable oil shortenings that are commonly employed in the baking industry. Plastic or hydrogenated glyceride shortenings derived most commonly from vegetable oils by hydrogenation are useful. Suitable oils include but are not limited to cottonseed oil, soybean oil, rapeseed oil, peanut oil, olive oil, palm oil, sunflower oil and the like. It is possible to use the roll-in shortening in a variety of forms such as chips, flakes, liquid or sheets.

Rolling in of the shortening can be accomplished using conventionally known equipment during a sheeting step in which alternating layers of dough and shortening placed upon each other. One such suitable machine is a Rondo sheeter (Rondo Inc., Moonachie, N.J.). To achieve the desired results of a laminated format for exemplary embodiments of the invention, substantially discrete and continuous shortening layers are prepared between the layers of dough. In embodiments of the invention, there are from about 2-36 substantially discrete and continuous layers of dough as well as from about 6-12 layers of dough. However, laminate doughs can comprise much greater number of layers, even up to 100 or more.

When a laminated dough pad such as that described herein is utilized, in combination with the dough formulation and the filling formulation described herein, the result is a high quality filled pastry with high structural integrity that is generally degradation resistant during frying, freezing, thawing, refrigeration and toasting.

In embodiments of the invention, the raw laminated dough pad has a thickness of about 5 mm or less, or 2 mm or less. With such pad dimensions, the product, after expansion during cooking, will still easily fit within a conventional toaster, toaster oven or microwave. In the case of a toaster, the product, even after expansion during toasting, can still be easily removed from the toaster without damage.

After the laminated dough pad is made, the laminated dough pad is filled with the cook-stable ice cream filling and is folded to form an encasing shell. This process can be referred to as “make up.” The make up process may vary but it generally includes dedusting the laminated dough pad. This step can comprise brushing off excess flour from the pad surface such as with rotating brush dedusters.

After dedusting, the laminated dough pad may be docked, followed by slitting to a desired width, and depositing, such as volumetric deposition, of the cook-stable ice cream filling. In embodiments of the invention, the cook-stable ice cream filling is deposited at a temperature less than its melting point or at a viscosity that allows it to be pumpable and depositable. A water spray can be applied along the edges of the sheet such that good effective sealing and seam integrity are achieved.

The folders and crimpers used in the baking industry are well known. With respect to the product of the type described herein, the laminated dough pad is folded upon itself, laying down the top dough piece after depositing the filling on the bottom dough piece. Folding can be accomplished manually or using mechanical implements such as a dough plow.

Free edges of the product can be finished by, for example, crimping. The folded edge can be crimped to provide all edges with a similar appearance. After crimping, a laminated dough pad having a plurality (e.g., 6-12) discrete and continuous layers, which completely surrounds the filling, is formed.

It has been found desirable to reduce the thickness of the laminated dough pad thickness less than a 50% during each pass through the rollers. Attempting to achieve a greater than 50% reduction in laminated dough pad thickness per pass, decreases the ability to obtain discrete and continuous layers in the laminated dough pad. Also, the dedusting technique discussed above removes excess flour that might cling to the laminated dough pad and interact with the filling on the inner surface of the dough pad.

Optionally, proofing the dough can be conducted for a sufficient time to allow a volume increase. This can be done for about 20-40 minutes, as well as about 20-30 minutes, at conventional proofing conditions such as temperatures of about 105-110° F. (40.6-43.3° C.) and at a relative humidity of about 40-70%. During proofmg the product can expand in volume as much as about 80%, with the laminated dough pad itself expanding in volume as much as about 100%. After proofmg, the product is ready for cooking, such as by frying or baking.

Constraint on the product can be utilized during cooking to assure appropriate dimensions in embodiments intended for heating in a conventional toaster. In such cases a constraint assures that the filled pastry will not expand to a thickness beyond which it will no longer fit within a toaster. For automated processes, the cooking can be done in a double restraint cooker. The filled pastry is restrained as it passes into the cooker by a lower conveyor screen upon which the filled pastry rests and is also at least partially constrained by an upper conveyor screen. During about the first quarter period of cooking, the product can ride wholly on the lower conveying screen without any upper constraint. Thereafter, as the product moves through the cooker (e.g., fryer), the filled pastry becomes constrained with respect to both the upper conveying screen as well as the lower conveying screen.

Cooking conditions are set to achieve a crisp surface and a moist but not gummy interior. Typically, these results can be achieved by frying at a temperature of about 350-425° F. (176.7-218.3° C.) for about 25-180 seconds. In embodiments of the invention, cooking is at a temperature of about 360-380° F. (182.2-193.3° C.) for about 40-50 seconds, as well as about 375° F. (190.6° C.) for about 37-45 seconds. Numerous frying oils may be used for frying the filled pastry. One suitable oil is Durkee's Durkex 100 (Loders Croklaan BV, Wormerveer, Netherlands).

For embodiments intended for heating or toasting in a conventional toaster, the product is conveyed so that immediately after cooking, as the product exits from the cooker, the gap between the constrained conveying screens is slightly decreased to provide a post-cooking thickness of about 15-20 mm. Such a size is especially suitable for placing in a conventional toaster.

After frying, the product can then be frozen and packaged. To enhance the shelf life of the filled pastry, the filled pastry is frozen during distribution and storage prior to consumption. As an alternative to heating the filled pastry in a conventional toaster, it is also possible to heat the filled pastry in other devices such as a microwave oven or a conventional oven.

The filled pastry can be provided in a pastry kit that also includes a topping composition. The topping composition can be prepared from a variety of materials such as diary-based ingredients, icing, fruit, syrups, particulates, peanut butter, decorative sprinkles, and combinations thereof.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A cook-stable ice cream filling for use as a filling in a fried pastry article, the cook-stable ice cream filling comprising: (a) ice cream; (b) water; (c) a high melting point fat; (d) a moisture binding agent; and (e) a humectant; wherein the ice-cream like filling has a melting point of about 59° F. (1 5° C.) or greater.

2. The cook-stable ice cream filling of claim 1, wherein the filling has a melting point ranging from about 68° F. (20° C.) or greater.

3. The cook-stable ice cream filling of claim 1, wherein the filling has a melting point ranging from about 68-86° F. (20-30° C.).

4. The cook-stable ice cream filling of claim 1, wherein the ice cream is present in an amount of about 20% wt. or greater.

5. The cook-stable ice cream filling of claim 1, wherein the high melting point fat is selected from the group consisting of palm oil, palm olein, palm kernel, cottonseed oil, and mixtures thereof.

6. The cook-stable ice cream filling of claim 1, wherein the high melting point fat has a melting point ranging from about 90-125° F. (32.2-51.7° C.).

7. The cook-stable ice cream filling of claim 1, wherein the high melting point fat is present in the filling in an amount ranging from about 10-30% wt.

8. The cook-stable ice cream filling of claim 1, wherein the moisture binding agent is selected from the group consisting of hydrocolloids such as cellulose compounds, starch, modified starch, carrageenan, carboxymethyl cellulose, locust bean gum, guar gum, and xanthan gum.

9. The cook-stable ice cream filling of claim 1, wherein the moisture binding agent is present in the filling in an amount ranging from about 0.1-8% wt.

10. The cook-stable ice cream filling of claim 1, wherein the cook-stable ice cream filling has a viscosity of about 90,000 cps or greater when measured at 69.8-73.4° F. (21-23° C.).

11. The cook-stable ice cream filling of claim 1, wherein the cook-stable ice cream filling has a viscosity ranging from about 90,000-240,000 cps when measured at 69.8-73.4° F. (21-23° C.).

12. The cook-stable ice cream filling of claim 1, wherein the humectant comprises an alcohol, saccharide, gum, salt, or mixture thereof.

13. The cook-stable ice cream fillings of claim 12, wherein the humectant comprises a monohydric alcohol, diol, polyol, monosaccharide, disaccharide, trisaccharide, salt, and mixtures thereof.

14. The cook-stable ice cream fillings of claim 12, wherein the humectant comprises glycerol, fructose, sucrose, glucose, propylene glycol, sodium chloride, sorbitol, mannitol, polydextrose, carboxymethyl cellulose, guar gum, molasses, potassium polymetaphosphate, triacetin, propionate, sodium lactate, monosodium glutamate, corn syrup, glycine, 1,2-propanediol, alginate, and mixtures thereof.

15. The cook-stable ice cream fillings of claim 1, wherein the humectant is present in an amount ranging from about 1-7% wt.

16. The cook-stable ice cream filling of claim 1, wherein the cook-stable ice cream filling comprises about 10-60% wt. water; greater than about 20% wt. ice cream; about 10-30% wt. high melting point fat; about 1-7% wt. humectant; and about 1-8% wt. moisture binding agent.

17. A filled pastry comprising:
(a) a pre-cooked outer dough piece that encases an inner filling layer; and
(b) an inner filling comprising a cook-stable ice cream filling comprising: (a) ice cream; (b) water; (c) a high melting point fat; (d) a moisture binding agent; and (e) a humectant; wherein the ice-cream like filling has a melting point of about 59° F. (15° C.) or greater.

18. The filled pastry of claim 17, wherein the pastry is capable of being heated in a toaster or microwave oven in order to form an outer dough piece having a temperature ranging from about 78.8-125.6° F. (26-52° C.); and an inner cook-stable ice cream filling that is substantially frozen.

19. The filled pastry of claim 18, wherein, after heating, the cook-stable ice cream filling has a temperature ranging from about 59-86° F. (15-30° C.).

20. A method of making a cooked filled pastry, the method comprising the steps of: (a) providing a cook-stable ice cream filling comprising (a) ice cream; (b) water; (c) a high melting point fat; (d) a moisture binding agent; and (e) a humectant; wherein the ice-cream like filling has a melting point of about 59° F. (15° C.) or greater; and wherein the cook-stable ice cream filling is a liquid; (b) applying the cook-stable ice cream filling to an uncooked dough piece; (c) encasing the cook-stable ice cream filling in the dough piece to form an uncooked filled pastry; and (d) cooking the uncooked filled pastry to form the cooked filled pastry; wherein the cooking step does not melt or degrade the cook-stable ice cream filling.
